(19) United States
(12) Patent Application Publication
(10) Pub. No.: US 2010/0188781 A1
(43) Pub. Date: Jul. 29, 2010

(54) MAGENTIC CIRCUIT FOR VCM AND STORAGE DEVICE

(75) Inventors: Takahiro ONO, Kawasaki-shi (JP); Hideki NISHIMOTO, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/753,726

(22) Filed: Apr. 2, 2010

Related U.S. Application Data
(63) Continuation of application No. PCT/JP2007/069295, filed on Oct. 2, 2007.

(51) Int. Cl. G11B 5/52

(52) U.S. Cl. 360/274; G9B/5.173

(57) ABSTRACT

According to one embodiment, a storage device includes at least one disk rotated by a spindle motor on a base formed of a magnetic material, a head actuator configured to access the disk, and a VCM configured to drive the actuator. A magnetic circuit of the VCM includes a top yoke with a flat plate-shape, a top magnet attached to a surface of the top yoke on the base side, and support portions formed on the base, and configured to support the top yoke, the top yoke being magnetically coupled to the support portions.

### CROSS REFERENCE TO RELATED APPLICATIONS

This is a Continuation Application of PCT Application No. PCT/JP2007/069295, filed Oct. 2, 2007, which was published under PCT Article 21(2) in Japanese.

### BACKGROUND

1. Field

One embodiment of the present invention relates to a magnetic circuit of a voice coil motor (VCM) and a storage device, and more particularly, to a structure of a magnetic circuit of a VCM incorporated in a small-sized magnetic disk device, and a storage device provided with the magnetic circuit.

2. Description of the Related Art

Heretofore, a hard disk drive (HDD) using a magnetic disk has become indispensable as a peripheral device configured to store computer data and image data. An HDD is also used as a storage device in apparatuses other than a computer. In, for example, an image recorder configured to record television pictures, a 3.5″ HDD is used, and a 2.5″ HDD is used in a car navigation device. Furthermore, in recent years, a 1.8″ HDD is used in a media player configured to reproduce music. Further, an HDD requires a simpler configuration with the progress of reduction in size.

In general, in an HDD, at least one disk rotated by a spindle motor, an actuator provided with a head configured to access the disk, and a voice coil motor (VCM) configured to drive the actuator, and the like are contained in a base made of a nonmagnetic material such as aluminum. When the base is made of a nonmagnetic material, the VCM is provided with a bottom yoke comprising a bottom magnet, and top yoke comprising a top magnet as shown in FIG. 2 of Jpn. Pat. Appln. KOKAI Publication No. 2008-112538. Parts on both sides of the top yoke are bent to form leg parts, and the leg parts are attached to the bottom yoke with a flat plate-like shape, thereby constituting a magnetic circuit.

On the other hand, in a 1.8″ HDD spreading in accordance with the trend of HDD toward size reduction, and an increase in capacity, the base consists of a cold-rolled steel plate (SPCC) as shown in Toshiba Review vol. 57 No. 7 (2002) “1.8 type magnetic disk device”. Further, in the 1.8″ HDD, the actuator is also small-sized, and hence the magnetic force driving the actuator may also be small. Accordingly, in the 1.8″ HDD, the bottom yoke, and bottom magnet are unnecessary, and hence only a top yoke provided with a top magnet is arranged on the base. The top yoke is bent at both sides thereof to form leg parts, and the leg parts are attached to the base. The leg parts constitute part of the magnetic circuit.

However, in the 1.8″ HDD, there has been a problem that simplification of the structure is required for the sake of reduction in size and weight, whereas the structure of the top yoke is unchanged from the conventional structure, both sides of the top yoke are subjected to bending processing for leg part formation twice, thereby complicating the bending processing. Furthermore, there has been a problem associated with the space that it is difficult to secure a place for attaching the top yoke to the base.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1A is an exemplary plan view showing the configuration of a 1.8″ HDD with a magnetic circuit of a VCM, according to a first embodiment of the present invention;

FIG. 1B is an exemplary perspective view showing the configuration of the magnetic circuit of the VCM of FIG. 1A;

FIG. 2A is an exemplary plan view showing the configuration of a 1.8″ HDD with a magnetic circuit of a VCM, according to a second embodiment the present invention;

FIG. 2B is an exemplary perspective view showing the magnetic circuit of the VCM of FIG. 2A, and a cover of the HDD;

FIG. 3A is an exemplary perspective view showing a magnetic circuit of a VCM of HDD, according to a third embodiment of the present invention;

FIG. 3B is an exemplary plan view of the magnetic circuit of FIG. 3A;

FIG. 4 is an exemplary perspective view showing a magnetic circuit of a VCM of HDD according to a fourth embodiment of the present invention;

FIG. 5A is an exemplary perspective view showing a magnetic circuit of a VCM of HDD according to a fifth embodiment of the present invention;

FIG. 5B is an exemplary exploded perspective view of a junction portion of the magnetic circuit of FIG. 5A, at which a cover and base are joined to each other;

FIG. 6 is an exemplary exploded perspective view showing a base of a magnetic circuit of a VCM and a top plate of HDD according to the second embodiment of the present invention;

FIG. 7A is an exemplary perspective view of a magnetic circuit according to a modification example of the third embodiment; and

FIG. 7B is an exemplary plan view of FIG. 7A.

### DETAILED DESCRIPTION

Various embodiments according to the invention will be described hereinafter with reference to the accompanying drawings. In general, according to one embodiment of the invention, there is provided a magnetic circuit of a VCM of a storage device in which at least one disk rotated by a spindle motor, a head actuator configured to access the disk, and a VCM configured to drive the actuator are arranged on a base formed of a magnetic material, the magnetic circuit comprising a top yoke with a flat plate-shape; a top magnet attached to a surface of the top yoke on the base side; and support portions formed on the base, and configured to support the top yoke, the top yoke being magnetically coupled to the support portions.

Embodiments of the present invention will be described in detail with reference to the drawings.

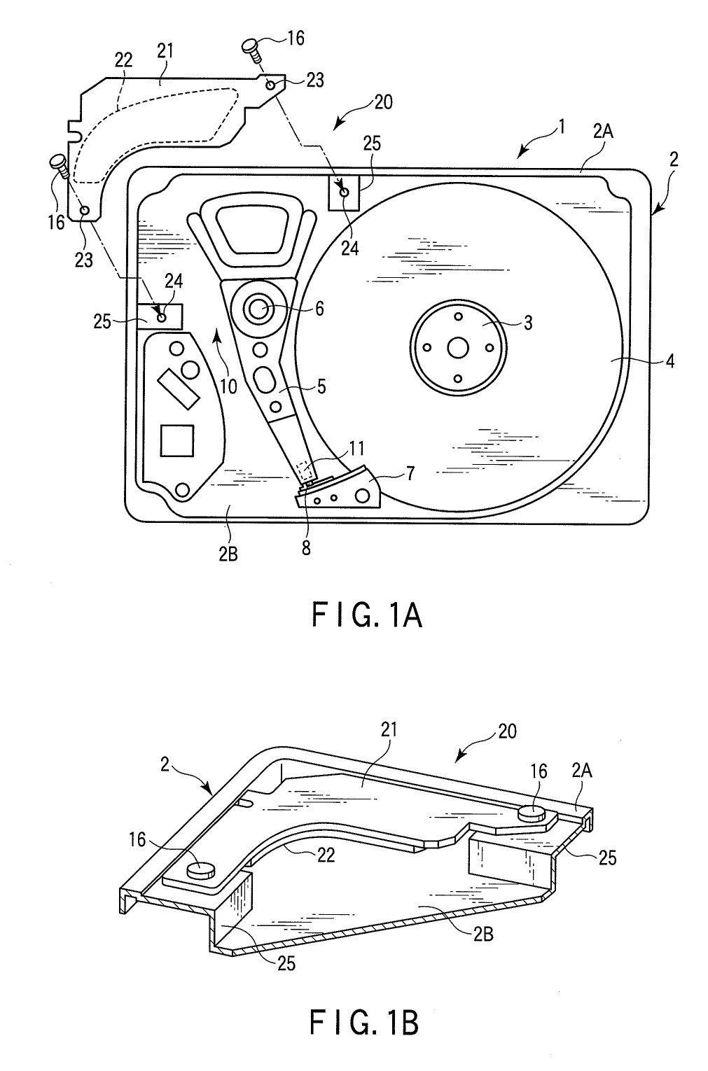

FIG. 1A is an exemplary plane view showing the configuration of a 1.8″ HDD 1 and a magnetic circuit 20 of a VCM 10 according to a first embodiment of the present invention, and FIG. 1B is a perspective view showing the configuration of the magnetic circuit 20. 1.8″ load/unload HDD 1 comprises a base 2 with a bottom surface 2B. On one side of the base 2 of the HDD 1 is provided at least one magnetic disk 4 as a storage medium, which is supported and rotated by a spindle motor 3. A large number of tracks for data recording are formed on a surface of the magnetic disk 4.

On the other side of the base 2 of the HDD 1, there is a swing arm 5 provided with a head 11 configured to read/write data. The swing arm 5 serves as a head actuator configured to access a track of the magnetic disk 4. The head 11 is attached to a distal end portion of the swing arm 5. The swing arm 5 is configured to swing around a pivot 6, and a voice coil motor (VCM) 10 configured to swing the swing arm 5 is provided on the opposite side of the swing arm 5 with respect to the pivot 6.

In the load/unload HDD 1, the head 11 is retracted outside the magnetic disk 4 at the unload time. For this purpose, the load/unload HDD 1 comprises a ramp 7 configured to hold a tab 8 at the distal end of the swing arm 5 on the bottom surface 2B of the base 2 in the vicinity of an outer circumferential edge of the magnetic disk 4. Part of the ramp 7 overlaps the magnetic disk 4.

The base 2 is formed of a cold-rolled steel plate (SPCC) which is a magnetic material. As a result of this, in a magnetic circuit 20 of the VCM 10 of the 1.8″ HDD 1, there are no bottom yoke and no bottom magnet, and the magnetic circuit 20 comprises only a top yoke 21 and a top magnet 22 on an undersurface of the top yoke 21. The top yoke 21 is arranged on the bottom surface 2B of the base 2.

In the magnetic circuit 20 of the VCM 10 of the first embodiment, the top yoke 21 is formed of a flat plate-shaped magnetic material plate. The top magnet 22 is attached to an undersurface of the top yoke 21 on the bottom surface 2B side of the base 2. The shape of the top yoke 21 in the plan view may be identical with the shape of the conventional top yoke in the plan view. Mounting holes 23 are formed in both ends of the top yoke 21.

On the bottom surface 2B of the base 2, support portions 25 configured to support both end portions of the top yoke 21 are formed integral with the base 2. The support portions 25 may be simultaneously formed with the base 2 at the time of manufacture (press working time) of the base 2. Further, in the first embodiment, although the shape of the support portion 25 is rectangular in the plan view, the shape and position of the support portion 25 are not limited to the shape and position of this embodiment, and may be a shape and position which are enable of supporting both end portions of the top yoke 21.

The height of the support portion 25 from the bottom surface 2B is slightly lower than the height of an outer peripheral wall 2A of the base 2 from the bottom surface 2B. A threaded hole 24 is formed in the top surface of the support portion 25. The position of the threaded hole 24 corresponds to each of the mounting holes 23 provided on both ends of the top yoke 21.

As shown in FIG. 1A, after the swing arm 5 is attached to the pivot 6, the mounting holes 23 of the top yoke 21 are aligned with the threaded holes 24 of the support portions 25, and the top yoke 21 is secured to the support portions 25 by means of screws 16. In the first embodiment, the top magnet 22, top yoke 21, support portions 25, and base 2 constitute a magnetic path in the magnetic circuit 20 of the VCM 10. In the magnetic circuit 20, the top yoke 21 is not subjected to bending processing, and hence advantages of a simple configuration and low cost are obtained. Since the base is formed of a magnetic material, and a bottom yoke is made unnecessary, it is possible to attach the top yoke to support portions provided on the base without subjecting the top yoke to bending processing, and hence it is possible to simplify the configuration. Further, an advantage that there is flexibility in the arrangement position of the support portion 25 on the base bottom surface 2B is obtained.

It should be noted that actually, a cover of the HDD 1 is attached to the upper edge of the peripheral wall 2A of the base 2 through a gasket. The cover will be described later in the later embodiment.

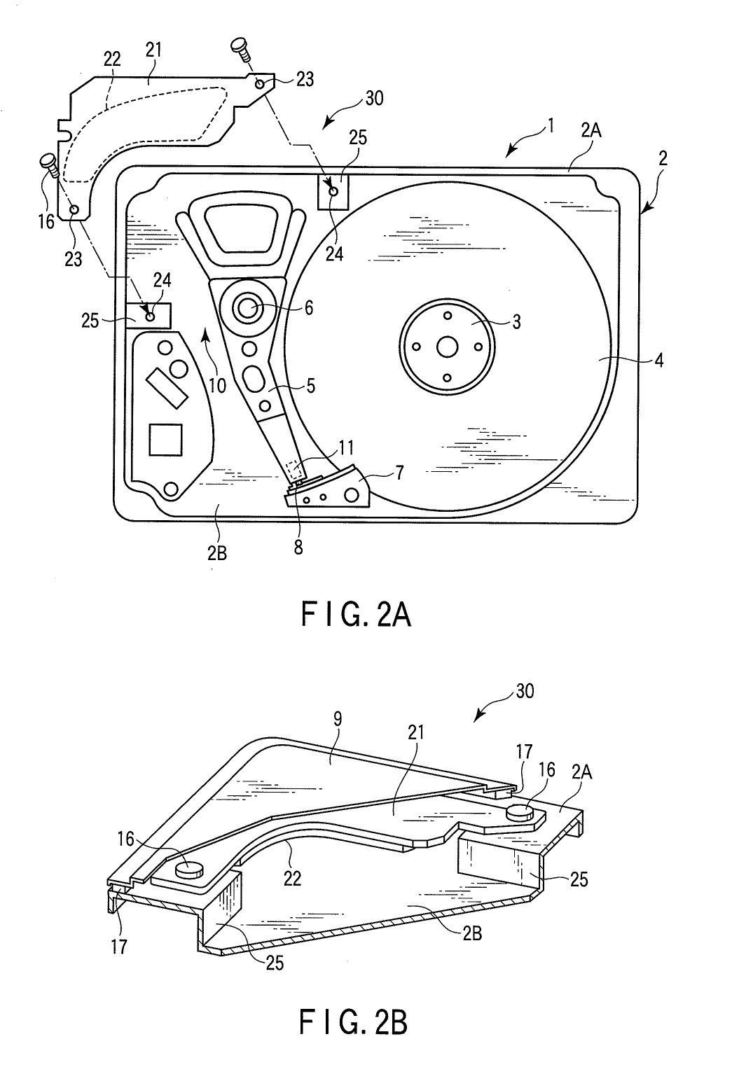

FIG. 2A is an assembly view showing the configuration of a 1.8″ HDD 1, and configuration of a magnetic circuit 30 of a VCM 10 according to a second embodiment of the present invention, and FIG. 2B is a perspective view showing the configuration of the magnetic circuit 30 of the VCM 10 of FIG. 2A and a cover 9 of the HDD 1. In the second embodiment, the top yoke 21 can be used as it is, and the second embodiment differs from the first embodiment only in the structure of the support portion 25 configured to support the top yoke 21. Accordingly, in the second embodiment, the constituent members identical with the first embodiment will be denoted by the identical reference symbols, and a description of them is omitted.

In the magnetic circuit 20 of the VCM 10 of the first embodiment, on the bottom surface 2B of the base 2, the support portions 25 configured to support both the end portions of the top yoke 21 are formed integral with the base 2, and the height of the support portions 25 from the base bottom surface 2B is slightly lower than the height of the upper edge portion 2A of the outer circumferential wall of the base 2 from the base bottom surface 2B. Thus, a step is formed between the support portions and a gasket mounting surface formed on an outer circumferential portion of the base. On the other hand, in the magnetic circuit 30 of the second embodiment, the height of the support portions 25 from the base bottom surface 2B is equal to the height of the upper edge portion 2A of the outer circumferential wall of the base 2 from the base bottom surface 2B. That is, the top surface of the support portion 25 and the upper edge portion 2A of the outer circumferential wall of the base 2 are on the same plane to be flush with each other.

The support portion 25 may also be simultaneously formed with the base 2 at the time of manufacture of the base 2. Threaded holes 24 corresponding to the mounting holes 23 provided on both sides of the top yoke 21 are formed in the top surfaces of the support portions 25, this being identical with the first embodiment. The shape and position of the support portion 25 in the plan view are not limited to the shape and position of this embodiment, and the shape and position are not limited if only the position enables both end portions of the top yoke 21 to be supported. As described above, by eliminating a difference in height between the upper edge portion 2A of the outer circumferential wall of the base 2 and the support portion 25, the magnetic flux is prevented from being concentrated at the corner portion of the step, and the magnetic flux can be uniformly saturated.

In assembling, the swing arm 5 is attached to the pivot 6, thereafter the mounting holes 23 of the top yoke 21 are aligned with the threaded holes 24 of the support portions 25, and the top yoke 21 is secured to the support portions 25 by means of screws 16. In the second embodiment, the top magnet 22, top yoke 21, support portions 25, and base 2 constitute a magnetic path in the magnetic circuit 30 of the VCM 10. A cover 9 of the HDD 1 is attached to the upper edge portion 2A of the outer circumferential wall of the base 2 through a gasket 17. The advantages of the magnetic circuit 30 of the second embodiment are identical with those in the first embodiment.

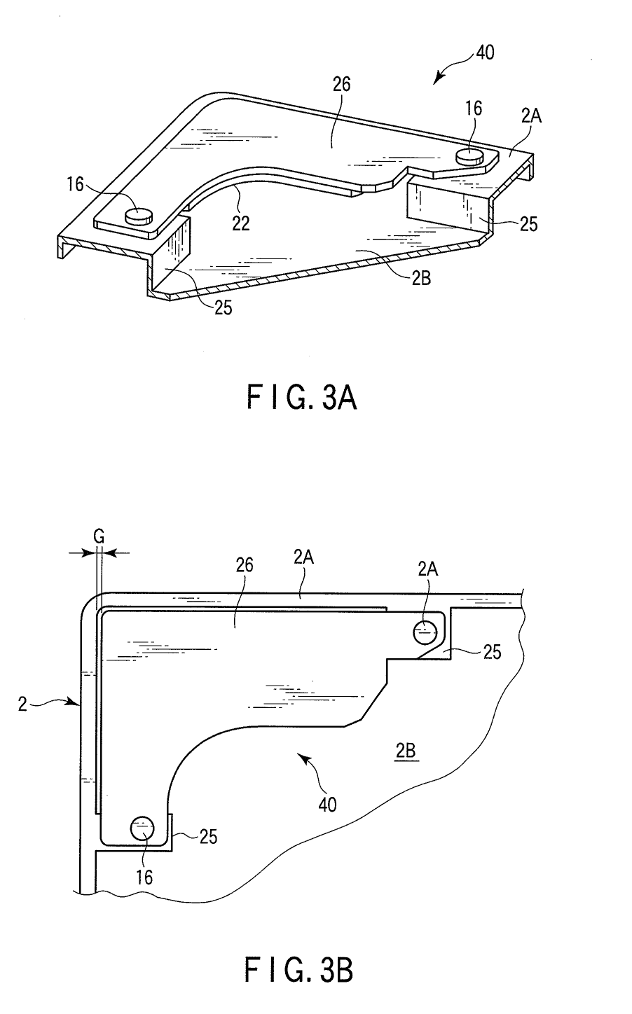

FIG. 3A is a perspective view showing the configuration of a magnetic circuit 40 of a VCM 10 according to a third embodiment of the present invention, and FIG. 3B is a plan view of the magnetic circuit 40 of FIG. 3A.

The third embodiment is substantially identical with the second embodiment described in connection with FIGS. 2A and 2B, and the third embodiment differs from the second embodiment only in the shape of a top yoke 26. Accordingly, in the third embodiment, the constituent members identical with the second embodiment are denoted by the identical reference symbols, and a description of them is omitted.

In a magnetic circuit 40 of a VCM 10 of the third embodiment, in order to improve the degree of magnetic saturation of the VCM 10, and enhance the magnetic efficiency, an end face of the top yoke 26 on the upper edge portion 2A side of the base extends to reduce the gap G between the top yoke 26 and the upper edge portion 2A. When the gap G between the end face of the top yoke 26 on the upper edge portion 2A side and the upper edge portion 2A is small, a magnetic path is formed between both two parts.

As a result of this, in the third embodiment, the magnetic path in the magnetic circuit 40 of the VCM 10 becomes large, the degree of magnetic saturation of the VCM 10 is improved, and the magnetic efficiency can be enhanced.

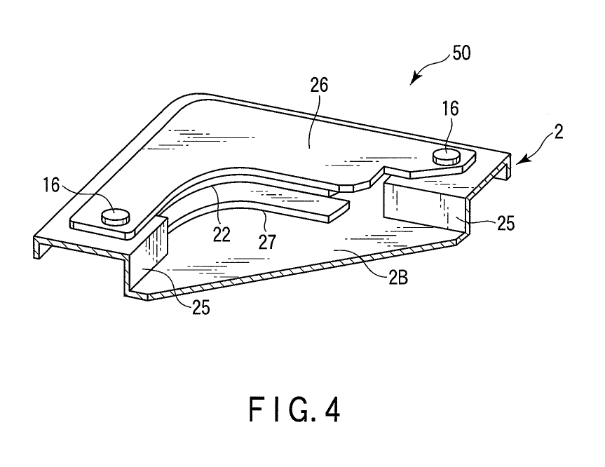

FIG. 4 is a perspective view showing the configuration of a magnetic circuit 50 of a VCM according to a fourth embodiment of the present invention. In the fourth embodiment, a bottom magnet 27 is added to the magnetic circuit 40 of the third embodiment. This is because in the third embodiment, the magnetic path in the magnetic circuit 40 of the VCM 10 becomes large, and the degree of magnetic saturation of the VCM 10 is improved. The bottom magnet 27 has only to be provided at a position on the base bottom surface 2B opposed to the top magnet 22.

When the bottom magnet 27 is directly attached to the bottom surface 2B of the base 2 as described above, the base is formed of a magnetic material in a 2.5″ HDD, and hence the base 2 can be used as a yoke. As a result of this, it is possible to further improve the magnetic characteristics, and enhance the performance of the HDD.

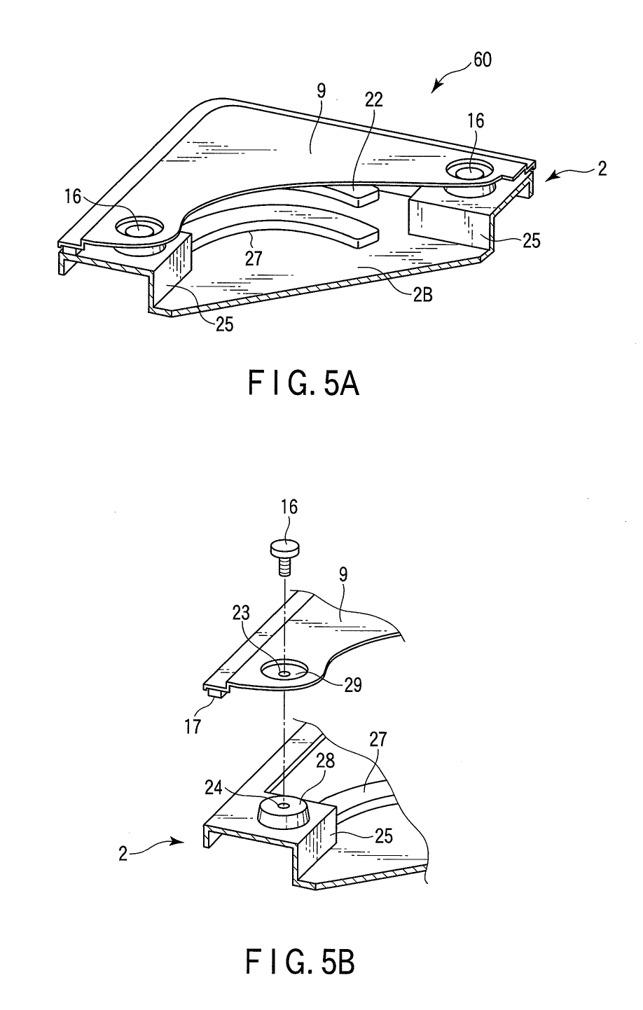

FIG. 5A is a perspective view showing the configuration of a magnetic circuit 60 of a VCM according to a fifth embodiment of the present invention, and FIG. 5B is an exploded perspective view of a junction portion of FIG. 5A at which a cover and base 2 are joined to each other.

Although in the first to fourth embodiments, a top magnet is provided on the undersurface of the top yoke 13, in the fifth embodiment, unlike in the first to fourth embodiments, a top magnet 22 is provided on an inner surface of a cover 9 of the HDD 1 described in the second embodiment. The cover 9 is formed of a magnetic material. Further, in the fifth embodiment, as in the fourth embodiment, a bottom magnet 27 is provided on the bottom surface 2B of the base 2 at a position opposed to the top magnet 22, and the base 2 which is a magnetic material is used as a yoke.

As described in the second embodiment, the cover 9 is connected to the base 2 through the gasket 17 which is a nonmagnetic material, and hence no magnetic path is formed between the cover 9 and the base. Thus, in the fifth embodiment, downwardly convex protruding portions 29 are formed on the cover 9 at positions outside both the end portions of the top magnet 22 as first junction portions as shown in FIG. 5B. A mounting hole 23 is formed at the central portion of each protruding portion 29.

On the bottom surface 2B of the base 2, support portions 25 are provided as second junction portions as in the embodiments described previously, protruding portions 28 are further formed on the top surfaces of the support portions 25. A threaded hole 24 is formed in the center of each protruding portion 28. The protruding portion 28 is configured to bring the support portion 25 into contact with the protruding portion 29 of the cover 9 when the cover 9 is attached to the base 2.

When the cover 9 is attached to the HDD 1, the threaded holes 24 of the protruding portions 29 are aligned with the threaded holes 24 of the protruding portions 28, both the protruding portions 28 and 29 are coupled to each other by means of screws 16 to make an electrical connection between them, thereby constituting a magnetic circuit by magnetic coupling.

As described above, in the fifth embodiment, the cover 9 of the HDD can be used as a yoke of the top magnet 22. In this case, the distance from the base bottom surface 2B to the top magnet 22 can be freely set by adjusting the thickness of the top magnet 22. The base is formed of a magnetic material, and a bottom yoke is made unnecessary, the magnetic circuit of the VCM is configured by using the cover of the storage device made of a magnetic material in place of a top yoke, and hence the configuration can be simplified. Further, it is possible to reduce the weight of the storage device.

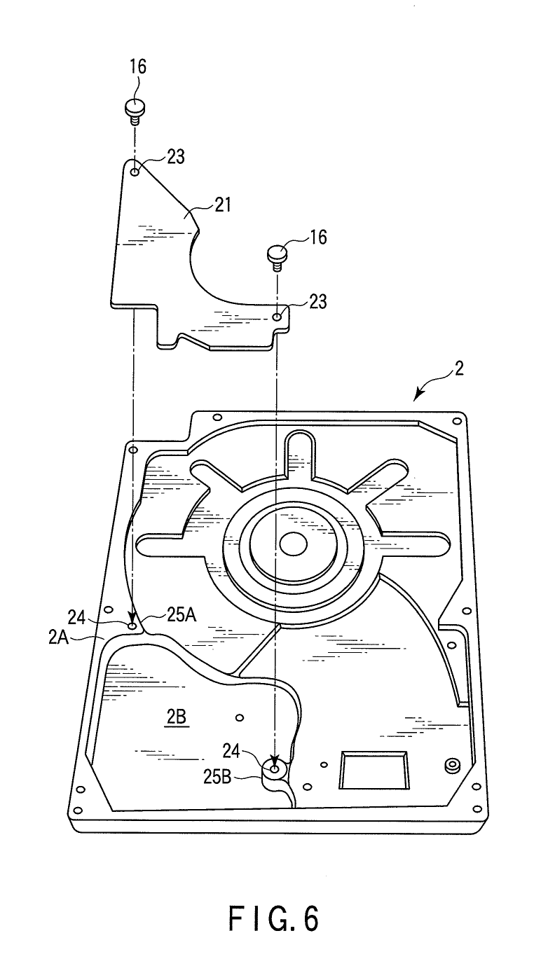

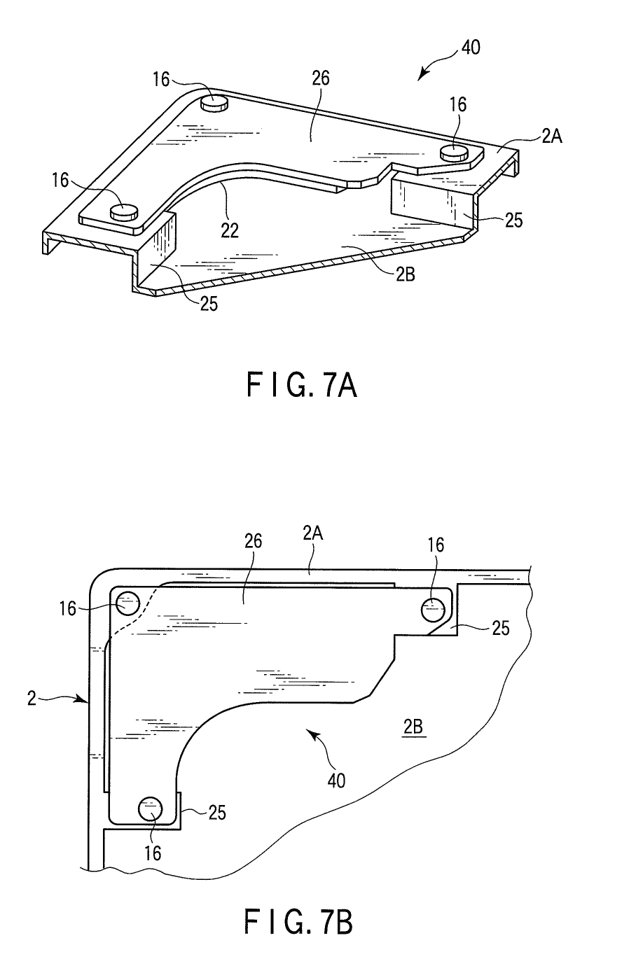

FIG. 6 shows the specific configuration of the magnetic circuit 30 of the VCM according to the second embodiment of the present invention, and only the base 2 and top yoke 21 are shown in FIG. 7. In this example, the support portion 25 closer to the magnetic disk is a continuous support portion 25A formed by inwardly protruding the upper edge portion 2A of the base 2 as it is. On the other hand, the other support portion 25 farther from the magnetic disk is an independent support portion 25B protruding from the bottom surface 2B of the base 2 at a position separate from the upper edge portion 2A of the base 2. The height of the top surface of the independent support portion 25B from the bottom surface 2B is equal to the height of the upper edge portion 2A of the base 2 from the bottom surface 2B.

In this example, it is possible to make the one mounting hole 23 of the top yoke 21 coincident with the threaded hole 24 of the continuous support portion 25A, make the other mounting hole 23 coincident with the threaded hole 24 of the independent support portion 25B, and secure the top yoke 21 to the support portions 25A and 25B by means of screws 16.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

It should be noted that the shape of the top yoke, and position and shape of the support portion for the top yoke are not limited to the embodiments described previously.

Further, the present invention is not limited to an HDD, and is also applicable to an optical disc device or a magneto-optical disk device, including a rotary actuator.

It should be noted that although in each of the examples which have been described above, the configuration in which only both the end portions of the top yoke 21 are supported by the support portions 25 has been described, the support of the top yoke 21 is not limited to two parts. For example, as in the modification example of the third embodiment of the present invention shown in FIGS. 7A and 7B, the top yoke 21 may be supported at three parts.

What is claimed is:

1. A magnetic circuit of a voice coil motor (VCM) of a storage device comprising at least one disk configured rotate with a spindle motor, a head actuator configured to access the disk, and a VCM configured to drive the actuator on a base comprising a magnetic material, the magnetic circuit comprising:
a top yoke with a flat plate-shape;
a top magnet attached to a surface of the top yoke on the base side; and
support portions on the base, and configured to support the top yoke, the top yoke being magnetically coupled to the support portions.

2. The magnetic circuit of claim 1, wherein the support portions are integrated with the base in manufacturing the base.

3. The magnetic circuit of claim 1, wherein a cover is attached to the base through a gasket, and
a step is located between the support portions and a gasket mounting surface on an outer circumferential portion of the base.

4. The magnetic circuit of claim 1, wherein a cover is attached to the base of the storage device through a gasket, and
top surfaces of the support portions and a gasket mounting surface on an outer circumferential portion of the base are on the same plane.

5. The magnetic circuit of claim 1, wherein a gap between the top yoke and an end surface of the base is substantially narrow in order to comprise a magnetic circuit between the top yoke and the end surface of the base.

6. The magnetic circuit of claim 1 further comprising a bottom magnet attached to a surface of the base facing the top magnet.

7. The magnetic circuit of claim 1, wherein end portions of the top yoke are attached to the support portions with screws.

8. A magnetic circuit of a VCM of a storage device comprising a spindle motor with at least one disk attached to the spindle motor, a head actuator configured to access the disk, and a VCM configured to drive the actuator in a base comprising a magnetic material, and the base is covered with a cover comprising a magnetic material, the magnetic circuit comprising:
a top magnet attached to a portion of the cover facing a coil of the VCM;
a first junction portion on the cover outside an end portion of the top magnet; and
a second junction portion on the base at a position facing the first junction portion;
wherein the cover is attached to the base and configured to magnetically couple the first and second junction portions to each other.

9. The magnetic circuit of claim 8, further comprising a bottom magnet attached to a surface of the base facing the top magnet.

10. The magnetic circuit of claim 9, wherein the first and second junction portions are coupled to each other with a screw.

11. A storage device comprising:
a base comprising a magnetic material;
at least one disk attached a spindle motor on the base;
a head actuator configured to access the disk; and
a VCM configured to drive the actuator and comprising a magnetic circuit, the magnetic circuit comprising a top yoke with a flat plate-shape, a top magnet attached to a surface of the top yoke on the base side, and support portions on the base and configured to support the top yoke,
wherein the top yoke is magnetically coupled to the support portions.

12. The storage device of claim 11, wherein the support portions are formed substantially at the same time with the base at manufacturing the base.

13. The storage device of claim 11, wherein a step is located between the support portions and a gasket mounting surface on an outer circumferential portion of the base.

14. The storage device of claim 11, wherein top surfaces of the support portions and a gasket mounting surface on an outer circumferential portion of the base are on the same plane.

15. The storage device of claim 11, wherein a gap between the top yoke and an end surface of the base is substantially narrow in order to comprise a magnetic circuit between the top yoke and the end surface of the base.

16. The storage device of claim 11 further comprising a bottom magnet attached to a surface of the base facing the top magnet.

17. The storage device of claim 11, wherein end portions of the top yoke are attached to the support portions with of screws.
